(19) United States
(12) Patent Application Publication
(10) Pub. No.: US 2009/0026950 A1
(43) Pub. Date: Jan. 29, 2009

(54) PLASMA DISPLAY PANEL

(75) Inventors: Hideki Harada, Miyazaki (JP); Toshiyuki Nanto, Miyazaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: FUJITSU HITACHI PLASAMA DISPLAY LIMITED, Kanagawa (JP)

(21) Appl. No.: 11/917,016

(22) PCT Filed: Sep. 2, 2005
(86) PCT No.: PCT/JP2005/016130

§ 371 Date: Dec. 10, 2007

(51) Int. Cl. H01J 17/49

(52) U.S. Cl. 313/582

(57) ABSTRACT

By making the thickness of a dielectric layer thinner than the thickness of each of electrodes, an opposed discharging phenomenon is exerted between the electrodes so that it becomes possible to reduce the discharging voltage between the electrodes. A plasma display panel is provided with a pair of substrates which are aligned face to face with each other with a discharge space placed inside thereof, a plurality of electrodes which are formed on the inner face of one of the substrates in a manner so as to be extended in a fixed direction, with a predetermined thickness, so that by generating a surface discharge, a screen display is carried out, and a dielectric layer which covers the electrodes, and in this structure, the dielectric layer is formed with a thickness which is thinner than the thickness of the electrodes.

### TECHNICAL FIELD

The present invention relates to a plasma display panel (hereinafter, referred to as PDP), and more particularly relates to a PDP in which upon discharging for display, a discharge voltage can be reduced.

### BACKGROUND ART

A three-electrode surface-discharge-type PDP of an AC-drive type has been known as a conventional PDP. This PDP has a structure in which a number of display electrodes capable of surface discharging are formed on an inner face of one of substrates (for example, a substrate on the front face side or the display face side) in a horizontal direction and a number of address electrodes for use in selecting light-emitting cells are formed on an inner face of the other substrate (for example, a substrate on the back face side) in a direction intersecting with the display electrodes so that each of intersections between the display electrodes and the address electrodes forms one cell (unit light-emitting area). One pixel is configured by three cells, that is, a red (R) cell, a green (G) cell and a blue (B) cell.

The display electrodes on the substrate on the front face side are covered with a dielectric layer. The address electrodes on the substrate on the back face side are also covered with a dielectric layer, with a barrier rib being formed between the address electrodes, and each of phosphor layers for R, G and B is formed between barrier ribs separating respective areas corresponding to the R cell, G cell and B cell.

The PDP is manufactured by processes in which, with the substrate on the front face side and the substrate on the back face side, thus prepared, being aligned face to face with each other, the peripheral portion is sealed, and a discharge gas is then sealed inside thereof (see the following Patent Document 1).

Patent Document 1: Unexamined Patent Publication JP2003-21304

### DISCLOSURE OF THE INVENTION

### Problems to be Solved by the Invention

In the above-mentioned PDP, the display electrodes are formed on the substrate on the front face side with a gap (discharge slit) which allows generation of a surface discharge being prepared in between, and each of them is configured by a transparent electrode made from ITO, SnO₂ or the like, and a bus electrode made of metal, such as copper and chromium, which is laminated on the transparent electrode. These electrodes are normally formed by a so-called known patterning method in which a metal film is formed by using a thin-film forming method such as a vapor deposition method, and after a resist film has been formed thereon by using a photolithographic technique, an etching process is carried out thereon.

Here, the display electrodes are covered with a dielectric layer. In general, this dielectric layer is formed through processes in which, after a low-melting-point glass paste has been applied onto a substrate and dried thereon, the resulting layer is fired. Normally, a paste prepared by adding a filler, such as ceramics, a binder resin, a solvent and the like to low-melting point glass flit is used as the low-melting-point glass flit. The method for forming this dielectric layer is a forming method generally referred to as a thick-film forming method.

In this manner, in the conventional PDP panel, since the display electrodes are formed by using a thin-film forming method, while the dielectric layer is formed by using a thick-film forming method, respectively, the dielectric layer is made thicker than the display electrodes. Moreover, since the dielectric layer is formed by using the thick-film forming method on the display electrodes which have been formed by using the thin-film forming method, the formation face of the dielectric layer is made virtually flat. For this reason, with respect to the side face portions of the display electrodes, hardly any charge is accumulated, and a discharge between the display electrodes is allowed to exert a surface discharging phenomenon.

However, in a case where a discharge between the display electrodes X and Y is exerted as a surface discharge, a high discharging voltage is required. Therefore, it has been demanded that the discharge voltage between the display electrodes X and Y is reduced in order to reduce the power consumption and the circuit costs.

The present invention has been devised to solve these problems, and its objective is to generate an opposed discharging phenomenon between the electrodes by making the thickness of the dielectric layer thinner than the thickness of the electrodes, and consequently to reduce a discharging voltage between the electrodes.

### Means to Solve the Problems

The present invention provides a plasma display panel comprising: a pair of substrates which are aligned face to face with each other, having a discharge space therebetween; a plurality of electrodes which are formed on the inner face of one of the substrates in a manner so as to be extended in a fixed direction, with a predetermined thickness, so that by generating a surface discharge, a screen display is carried out; and a dielectric layer which covers the electrodes, wherein the dielectric layer is formed with a thickness which is thinner than the thickness of the electrodes.

### EFFECTS OF THE INVENTION

In the present invention, since the dielectric layer is formed with a thickness thinner than that of the electrodes, a charge is also formed on the barrier rib portions of the electrodes so that the quantity of accumulated charge increases correspondingly. Moreover, since an opposed discharging phenomenon is exerted on the barrier rib portions of the electrodes, the discharging voltage between the display electrodes is greatly reduced in comparison with that of the surface discharging system.

### BRIEF DESCRIPTION OF THE DRAWINGS

FIG. 1(a) and FIG. 1(b) are explanatory views showing a structure of a PDP according to the present invention.

FIG. 2 is an explanatory view showing cross-sectional shapes of display electrodes and a dielectric layer of Embodiment 1.

FIG. 3 is an explanatory view showing cross-sectional shapes of display electrodes and a dielectric layer of Embodiment 2.

FIG. 4 is an explanatory view showing a structure of Comparative Example 1.

FIG. 5 is an explanatory view showing a structure of Comparative Example 2.

FIG. 6 is an explanatory view showing a structure of Comparative Example 3.

### REFERENCE NUMERALS

10 PDP
11 Substrate on front face side
17 Dielectric layer on front face side
18 Protective film
21 Substrate on back face side
24 Dielectric layer on back face side
28R, 28G, 28B Phosphor layer
29 Barrier rib
30 Discharge space
A Address electrode
L Display line
X, Y Display electrode
Xa, Yb Side wall portion of display electrode

### BEST MODE FOR CARRYING OUT THE INVENTION

In the present invention, it is only necessary for a pair of substrates to be placed face to face with each other with a discharge space located inside thereof. Examples of the substrate include a substrate made from glass, quartz, ceramics or the like, and a substrate on which desired components, such as electrodes, an insulating film, a dielectric layer and a protective film, are formed on such a substrate.

A plurality of electrodes are formed on an inner face of one of the paired substrates with a predetermined thickness, in an extended state in a fixed direction, so that they are allowed to generate a surface discharge to carry out a screen display. These electrodes can be formed by using various known materials and methods in the corresponding field. Examples of materials to be used for the electrodes include a transparent conductive material, such as ITO and SnO₂, and a metal conductive material, such as Ag, Au, Al, Cu and Cr. Various known methods in the corresponding field may be adopted as the method for forming the electrodes. For example, a thick-film forming technique, such as printing, may be used, or a thin-film forming technique, such as a physical deposition method or a chemical deposition method, may be used. With respect to the thick-film forming technique, for example, a screen-printing method is used. With respect to the physical deposition method of the thin-film forming technique, a vapor deposition method and a sputtering method may be used. With respect to the chemical deposition method, a thermal CVD method, a photo CVD method, or a plasma CVD method is used. More specifically, with respect to the electrodes, metal electrodes having a three-layer structure made of Cr/Cu/Cr and metal electrodes made of aluminum may be used. Moreover, a paste fired film, formed by applying paste of Ag or Au thereto to be fired thereon, may be used.

The dielectric layer is designed to cover the electrodes, and preferably formed on the electrodes in an isotropic manner. The term, “isotropic manner”, means that the dielectric layer is formed with a virtually uniform thickness in accordance with the shape of the electrodes, when viewed on the cross section taken in a direction perpendicular to the extending direction of the electrodes. For example, the dielectric layer is preferably prepared as a SiO₂ film formed by a vapor phase film-forming method, and when formed by using such a vapor phase film-forming method, the dielectric layer is allowed to have an isotropic thickness with respect to the electrodes. However, this dielectric layer is not intended to be limited to the SiO₂ film formed by the vapor phase film-forming method as long as it satisfies the condition that it is made thinner than the thickness of the electrodes, and may be formed by using various known materials and methods in the corresponding field.

With respect to the relationship between the electrodes and the dielectric layer, each of the electrodes may have a virtually rectangular shape when viewed on the cross section taken in a direction perpendicular to the extending direction of the electrodes, and the dielectric layer may have virtually the same thickness on the upper face and on the side face of each electrode when viewed on the cross section taken in a direction perpendicular to the extending direction of the electrodes. Moreover, each of the electrodes may have a virtually semi-circular shape when viewed on the cross section taken in a direction perpendicular to the extending direction of the electrodes, and the dielectric layer may be formed with virtually the same thickness along the semi-circular shape of each electrode, when viewed on the cross section taken in a direction perpendicular to the extending direction of the electrodes.

With respect to the electrode having a virtually rectangular shape in its cross section, examples thereof include a metal electrode having a three-layer structure made of Cr/Cu/Cr, and a metal electrode made of aluminum. With respect to the electrode having a virtually semi-circular shape in its cross section, examples thereof include a metal electrode made of a silver paste fired film.

Based upon an embodiment with reference to the drawings, the following description will discuss the present invention in detail. However, the present invention is not intended to be limited by this, and various modifications may be made therein.

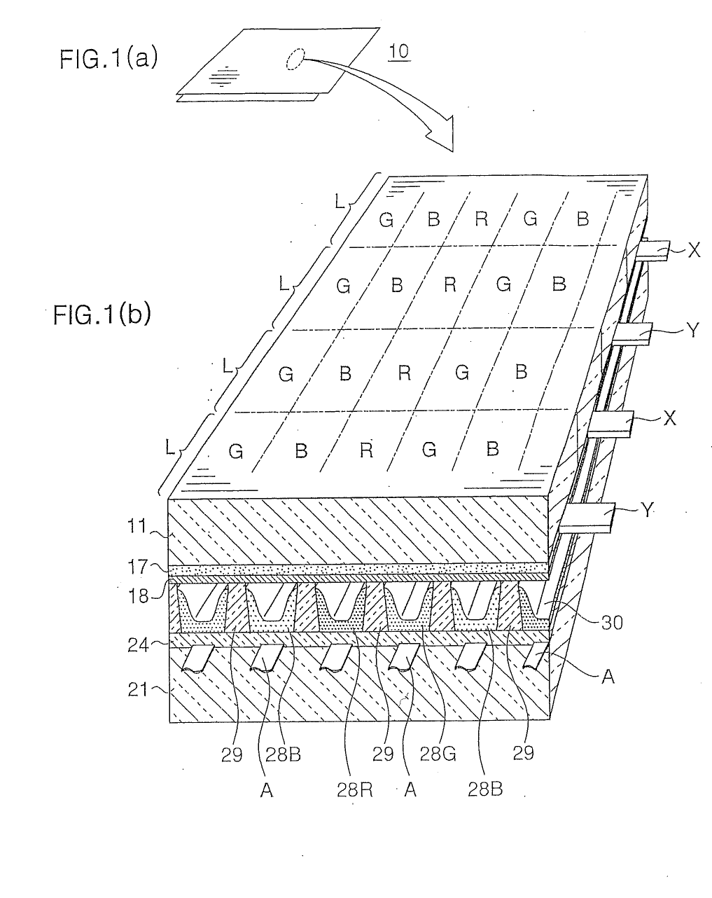

FIG. 1(a) and FIG. 1(b) are explanatory views showing a structure of a PDP according to the present invention. FIG. 1(a) is a general view, and FIG. 1(b) is a partially exploded perspective view thereof. This PDP is a surface-discharge type PDP with three electrodes of AC-drive type used for color display.

This PDP 10 is configured by a substrate 11 on a front face side and a substrate 21 on a back face side. For example, a glass substrate, a quartz substrate, a ceramic substrate or the like may be used as the substrate 11 on the front face side and the substrate 21 on the back face side.

On the inner face of the substrate 11 on the front face side, display electrodes X and display electrodes Y are placed in a horizontal direction with equal intervals. Each of gaps between adjacent display electrodes X and display electrodes Y forms a display line L. Each of the display electrodes X and Y is an electrode made of metal, formed by using, for example, Ag, Au, Al, Cu, or Cr, or a laminated body thereof (for example, laminated structure of Cr/Cu/Cr). Each of these display electrodes X and Y may be formed as a laminated body configured by a transparent electrode with a wide width, made of ITO, SnO₂ or the like, and a bus electrode with a narrow width, made of any one of the above-mentioned metals. Upon forming these display electrodes X and Y, a thick-film-forming technique such as a screen-printing process is used for Ag and Au, and a thin-film-forming technique, such as a vapor deposition method and a sputtering method, and an etching technique are used for the other materials so that a desired number of electrodes having desired thickness, width and gap can be formed. Here, the display electrode X is also referred to simply as “X electrode”, and the display electrode Y is also referred to simply as “Y electrode”.

Here, in the present PDP, a PDP having a so-called ALIS structure in which display electrodes X and display electrodes Y are placed with equal intervals, with each gap between the adjacent display electrode X and display electrode Y being allowed to form a display line L, has been exemplified; however, the method for forming barrier ribs of the present invention may also be applied to a PDP having a structure in which paired display electrodes X and Y are placed separately, with a distance (non-discharge gap) in which the paired display electrodes X and Y generate no discharge.

On the display electrodes X and Y, an alternating-current (AC) driving dielectric layer 17 on the front face side is formed in a manner so as to cover the display electrodes X and Y. The dielectric layer 17 is formed by film-forming a SiO₂ film thereon by using a plasma CVD method.

A protective film 18, used for protecting the dielectric film 17 from damage due to collision of ions generated by discharge upon display, is formed on the dielectric layer 17. This protective film is made from MgO or the like. The protective film may be formed by using a known thin-film forming process in the corresponding field, such as an electron beam vapor deposition method and a sputtering method.

On the inner side face of the substrate 21 on the back face side, a plurality of address electrodes A are formed in a direction intersecting with the display electrodes X and Y as seen from the plan view, and a dielectric layer 24 on the back face side is formed in a manner so as to cover the address electrodes A. Each of the address electrodes A that generate an address discharge used for selecting cells to emit light at intersections with the display electrodes Y is formed into a three-layer structure of Cr/Cu/Cr. These address electrodes A may also be formed by using, for example, Ag, Au, Al, Cu and Cr. In the same manner as in the display electrodes X and Y, upon forming these address electrodes A, a thick-film-forming technique such as a screen-printing process is used for Ag and Au, and a thin-film-forming technique, such as a vapor deposition method and a sputtering method, and an etching technique are used for the other materials so that a desired number of electrodes having desired thickness, width and gap can be formed. On the address electrodes A, a dielectric layer 24 is formed in a manner so as to cover the address electrodes A. The dielectric layer 24 is formed through processes in which a low-melting-point glass paste is applied on the substrate 21 on the back face side by using a screen-printing method, and fired thereon. In the same manner as in the dielectric layer covering the display electrodes, the dielectric layer 24 may be formed by film-forming a SiO₂ film thereon by using a plasma CVD method.

A plurality of barrier ribs 29 having a stripe shape are formed on the dielectric layer 24 between the adjacent address electrode A and address electrode A. Not limited to this shape, the shape of the barrier ribs 29 may have a mesh shape (a box shape) that divides the discharge space for each of the cells. The barrier ribs 29 may be formed by using a method, such as a sand blasting method, a printing method and a photo-etching method. For example, in the sand blasting method, a glass paste, made from a low-melting-point glass flit, a binder resin and a solvent, is applied onto the dielectric layer 24 and dried thereon, and cutting particles are then blasted onto the glass paste layer, with a cutting mask having openings corresponding to the barrier rib pattern being attached thereto, so that the glass paste layer exposed to the openings of the mask is cut off, and this is fired to form the barrier ribs. Moreover, in the photo-etching method, in place of the cutting process by the use of the cutting particles, a photosensitive resin is used as the binder resin, and after exposing and developing processes by the use of a mask, a firing process is carried out thereon to form the barrier ribs.

On the dielectric layer 24, phosphor layers 28R, 28G and 28B corresponding to red (R), green (G) and blue (B) are formed on the side faces of the barrier ribs 29 and the gaps between the barrier ribs. The phosphor layers 28R, 28G and 28B are formed through processes in which a phosphor paste containing phosphor powder, a binder resin and a solvent is applied onto the inside a discharge space having a concave groove shape between the barrier ribs 29 by using a screen-printing method or a method using a dispenser, and after these processes have been repeated for each of the colors, a firing process is carried out. These phosphor layers 28R, 28G and 28B may also be formed by using a photolithographic technique through processes in which a sheet-shaped phosphor layer material (so-called green sheet) containing phosphor powder, a photosensitive material and a binder resin is used. In this case, a sheet having a desired color is affixed onto the entire face of a display area on a substrate, and the sheet is subjected to exposing and developing processes; thus, by repeating these processes for each of the colors, the phosphor layers having the respective colors are formed in the corresponding gaps between the barrier ribs.

The PDP is manufactured through processes in which the substrate 11 on the front face side and the substrate 21 on the back face side are placed so as to face each other in a manner so as to allow the display electrodes X, Y and address electrodes A to intersect with each other, and the peripheral portion thereof is sealed, with a discharge space 30 surrounded by barrier ribs 29 being filled with a discharge gas formed by mixing Xe and Ne. In this PDP, the discharge space 30 at each of intersections between the display electrodes X and Y and the address electrodes A forms one cell (unit light-emitting area) that is the minimum unit of display. One pixel is configured by three cells of R, G and B.

### EMBODIMENT 1

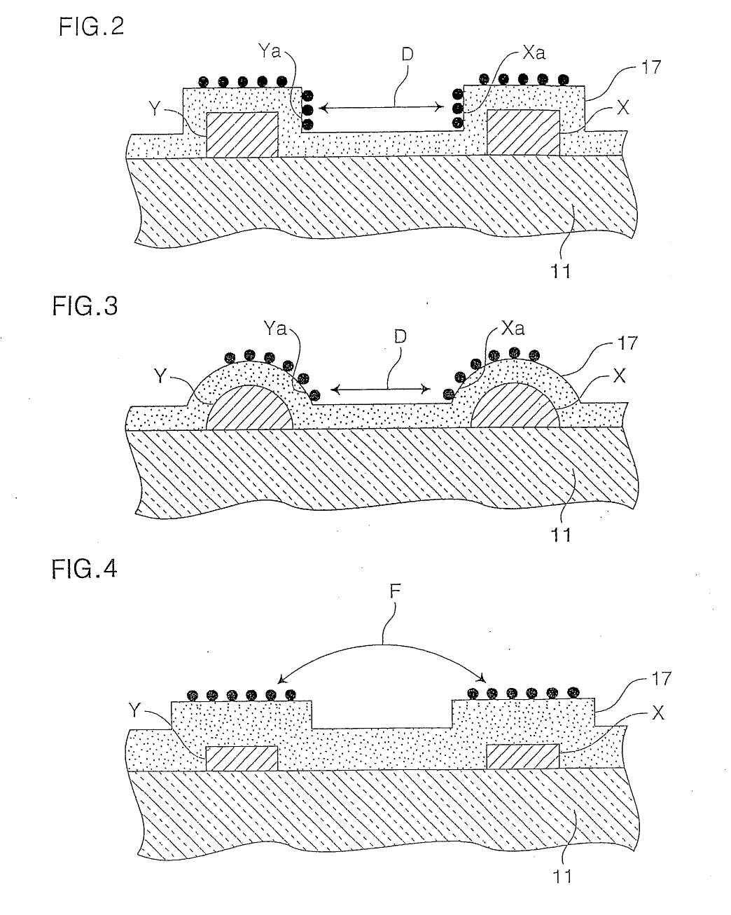

FIG. 2 is an explanatory view showing a cross-sectional shape of display electrodes and a dielectric layer of Embodiment 1. The cross section in this Figure is taken in a direction perpendicular to the display electrodes.

As shown in this Figure, in the substrate 11 on the front face side, the dielectric layer 17 is made thinner than the display electrodes X and Y.

Each of the display electrodes X and Y, which is an electrode made of metal having a three-layer structure of Cr/Cu/Cr, is formed by using known photolithographic and etching techniques in the corresponding field. That is, after forming metal films corresponding to three layers of Cr/Cu/Cr by using a vacuum vapor deposition method on the glass substrate 11 on the display surface side with a thickness in a range from 3 to 8 μm, the metal films are laminated with a dry-film resist, or coated with a liquid-state resist, so that a resist film is formed on the metal films, and this is then subjected to exposing and developing processes through a photo-mask so that unnecessary portions of the resist film are removed, and a wet-etching process is carried out thereon to form a pattern of electrodes. The display electrodes X and Y thus formed have a rectangular shape in the cross-sectional shape thereof.

In another structure, the display electrodes X and Y may be formed as aluminum electrodes. In this case, in place of the above-mentioned three layers of metal films, an aluminum metal film is formed with a thickness in a range from 3 to 8 μm, and the electrodes are formed by using photolithographic and etching techniques.

The dielectric layer 17 is formed so as to cover the display electrodes X and Y. The dielectric layer 17 is made thinner than the thickness of the display electrodes X and Y, that is, 3 to 8 μm. In other words, it is formed by film-forming a SiO₂ film by a plasma CVD method with a film thickness in a range from 2 to 7 μm. When the dielectric layer 17 is formed by using such a thin-film forming method, the dielectric layer 17 is formed with an isotropic thickness. That is, the layer is formed with a fixed thickness according to the shape of the base layer to be formed.

Although not shown in the Figure, an MgO film is formed on the dielectric layer 17 with a thickness in a range from 0.5 to 0.7 μm as a protective film. Since this protective film is also formed by using the thin-film forming method, it is formed with a fixed thickness according to the shape of the base layer to be formed.

Since the dielectric layer 17 is made thinner than the display electrodes X and Y, charges (indicated by black circles in the Figure) are formed on the side wall portions Xa and Ya of the X electrode and Y electrode so that the quantity of accumulated charge becomes greater. Moreover, since the side wall portions Xa and Ya of the X electrode and Y electrode are allowed to exert an opposed discharging phenomenon (indicated by D in the Figure), the discharging voltage can be greatly lowered in comparison with the generation of surface discharge. By making the distance between the X electrode and the Y electrode shorter, this structure is allowed to function more effectively.

### EMBODIMENT 2

FIG. 3 is an explanatory view showing a cross-sectional shape of display electrodes and a dielectric layer of Embodiment 2. The cross section in this Figure is also taken in a direction perpendicular to the display electrodes.

In the present embodiment, the materials of the display electrodes X and Y and the forming method thereof are different from those of Embodiment 1. That is, an Ag paste film is formed as the display electrodes X and Y by applying a silver (Ag) paste thereto by using a screen printing method to be dried thereon, and this is put in a firing furnace and fired at 550 to 600° C. for about one hour so that an Ag paste fired film with a thickness of 8 μm is formed. The cross-sectional shape of the display electrodes X and Y thus formed has a semi-circular shape, with a thickness of 8 μm in the thickest portion.

The dielectric layer 17 is formed so as to cover the display electrodes X and Y. The dielectric layer 17 is made thinner than the thickness of the display electrodes X and Y, that is, 8 μm. In other words, it is formed by film-forming a SiO₂ film by a plasma CVD method with a film thickness in a range from 2 to 7 μm in the same manner as in Embodiment 1.

In the same manner as in Embodiment 1, an MgO film is formed on the dielectric layer 17 with a thickness in a range from 0.5 to 0.7 μm as a protective film.

In the present Embodiment also, the dielectric layer 17 is made thinner than the display electrodes X and Y, in the same manner as in Embodiment 1. Therefore, charges (indicated by black circles in the Figure) are formed on the side wall portions Xa and Ya of the X electrode and Y electrode so that the quantity of accumulated charge consequently becomes greater. Moreover, since the side wall portions Xa and Ya of the X electrode and Y electrode are allowed to exert an opposed discharging phenomenon (indicated by D in the Figure), the discharging voltage can be greatly lowered in comparison with the generation of surface discharge. In the present structure also, by making the distance between the X electrode and the Y electrode shorter, this structure functions more effectively.

### EXAMPLE 1

In this Example, a PDP was manufactured by using the structure of Embodiment 1. That is, after having formed metal electrodes of three layers of Cr (0.2 μm)/Cu (6 μm)/Cr (0.2 μm) on a glass substrate 11 on the display surface side as display electrodes, a SiO₂ film of 3 μm was formed thereon as a dielectric layer by a plasma CVD method. Then, an MgO film of 0.7 μm was formed thereon as a protective layer, and this was bonded to a substrate on the back face side and the substrates were evacuated, and a mixed gas of Ne 90%-Xe 10% was sealed into a discharge space between the substrates so that a PDP was manufactured. As a result of evaluation of the panel, the discharge starting voltage was 180 V and the light-emitting efficiency was 1.8 lm/W.

### EXAMPLE 2

In this Example, a PDP was manufactured by using the structure of Embodiment 2. That is, an Ag paste film was formed by using a screen printing method on a glass substrate 11 on the display surface side as display electrodes, and after having been dried, this was fired so that an Ag paste fired film of 8 μm was formed, and a SiO₂ film of 3 μm was then formed thereon as a dielectric layer by a plasma CVD method. Thereafter, an MgO film of 0.7 μm was formed thereon as a protective layer, and this was bonded to a substrate on the back face side and the substrates were evacuated, and a mixed gas of Ne 90%-Xe 10% was sealed into a discharge space between the substrates so that a PDP was manufactured. As a result of evaluation of the panel, the discharge starting voltage was 178 V and the light-emitting efficiency was 1.8 μm/W.

The following description will discuss Comparative Examples. The Comparative Examples have a structure in which the dielectric layer 17 is not made thinner than each of the dielectric electrodes X and Y.

### COMPARATIVE EXAMPLE 1

FIG. 4 shows a structure of Comparative Example 1. After having formed metal electrodes of three layers of Cr (0.2 μm)/Cu (3 μm)/Cr (0.2 μm) on a glass substrate 11 on the display surface side as display electrodes, a SiO₂ film of 10 μm was formed thereon as a dielectric layer by a plasma CVD method. Then, an MgO film of 0.7 μm was formed thereon as a protective layer, and this was then bonded to a substrate on the back face side and the substrates were evacuated, and a mixed gas of Ne 90%-Xe 10% was sealed into a discharge space between the substrates so that a PDP was manufactured. As a result of evaluation of the panel, the discharge starting voltage of surface discharge (indicated by F in the Figure) was 210 V and the light-emitting efficiency was 1.5 μm/W.

### COMPARATIVE EXAMPLE 2

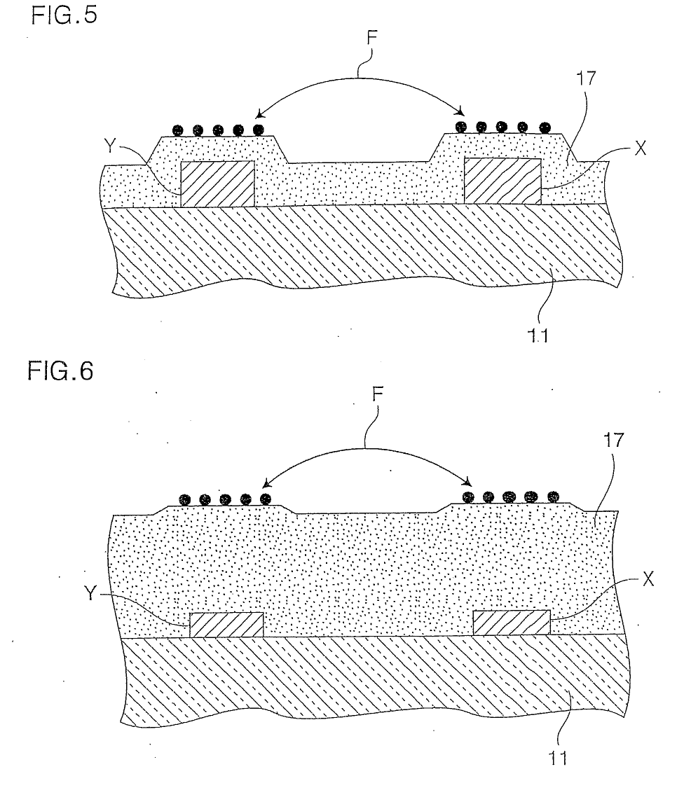

FIG. 5 shows a structure of Comparative Example 2. After having formed metal electrodes of three layers of Cr (0.2 μm)/Cu (6 μm)/Cr (0.2 μm) on a glass substrate 11 on the display surface side as display electrodes, a low-melting-point glass paste was applied thereto and fired thereon by a screen printing method so that a low-melting-point glass film of 10 μm was formed thereon as a dielectric layer. Thereafter, an MgO film of 0.7 μm was formed thereon as a protective layer, and this was then bonded to a substrate on the back face side and the substrates were evacuated, and a mixed gas of Ne 90%-Xe 10% was sealed into a discharge space between the substrates so that a PDP was manufactured. As a result of evaluation of the panel, the discharge starting voltage of surface discharge (indicated by F in the Figure) was 200 V and the light-emitting efficiency was 1.3 μm/W.

### COMPARATIVE EXAMPLE 3

FIG. 6 shows a structure of Comparative Example 3. After having formed metal electrodes of three layers of Cr (0.2 μm)/Cu (3 μm)/Cr (0.2 μm) on a glass substrate 11 on the display surface side as display electrodes, a low-melting-point glass paste was applied thereto and fired thereon by a screen printing method so that a low-melting-point glass film of 20 g/m was formed thereon as a dielectric layer. Thereafter, an MgO film of 0.7 μm was formed thereon as a protective layer, and this was then bonded to a substrate on the back face side and the substrates were evacuated, and a mixed gas of Ne 90%-Xe 10% was sealed into a discharge space between the substrates so that a PDP was manufactured. As a result of evaluation of the panel, the discharge starting voltage of surface discharge (indicated by F in the Figure) was 230 V and the light-emitting efficiency was 1.42 lm/W.

### COMPARATIVE EXAMPLE 4

In this Comparative Example, the thickness of the dielectric layer was set to 30 μm. The present Comparative Example differs from Comparative Example 3 only in this point, and the other structures are the same as those of Comparative Example 3.

After having formed metal electrodes of three layers of Cr (0.2 μm)/Cu (3 μm)/Cr (0.2 μm) on a glass substrate 11 on the display surface side as display electrodes, a low-melting-point glass paste was applied thereto and fired thereon by a screen printing method so that a low-melting-point glass film of 30 μm was formed thereon. Thereafter, an MgO film of 0.7 μm was formed thereon as a protective layer, and this was then bonded to a substrate on the back face side and the substrates were evacuated, and a mixed gas of Ne 90%-Xe 10% was sealed into a discharge space between the substrates so that a PDP was manufactured. As a result of evaluation of the panel, the discharge starting voltage was 245 V and the light-emitting efficiency was 1.53 μm/W.

As described above, by forming the dielectric layer with a thickness thinner than that of the electrodes, a charge is also formed on the barrier rib portions of the electrodes so that the quantity of accumulated charge increases correspondingly. Moreover, since an opposed discharging phenomenon is exerted on the barrier rib portions of the electrodes, the discharging voltage between the display electrodes can be greatly reduced in comparison with the surface discharging system.

1. A plasma display panel comprising:
a pair of substrates which are aligned face to face with each other, having a discharge space therebetween;
a plurality of electrodes which are formed on the inner face of one of the substrates in a manner so as to be extended in a fixed direction, with a predetermined thickness, so that by generating a surface discharge, a screen display is carried out; and
a dielectric layer which covers the electrodes,
wherein the dielectric layer is formed with a thickness which is thinner than the thickness of the electrodes.

2. The plasma display panel according to claim 1, wherein the dielectric layer is formed on the electrodes in an isotropic manner.

3. The plasma display panel according to claim 1, wherein the dielectric layer is a SiO₂ film formed by a vapor phase film-forming method.

4. The plasma display panel according to claim 1, wherein each of the electrodes has a virtually rectangular shape when viewed on the cross section taken in a direction perpendicular to the extending direction of the electrodes, and the dielectric layer has virtually the same thickness on the upper face and on the side face of each electrode when viewed on the cross section taken in a direction perpendicular to the extending direction of the electrodes.

5. The plasma display panel according to claim 4, wherein each of the electrodes is a metal electrode having a three-layer structure of Cr/Cu/Cr.

6. The plasma display panel according to claim 4, wherein each of the electrodes is a metal electrode made of aluminum.

7. The plasma display panel according to claim 1, wherein each of the electrodes has a virtually semi-circular shape when viewed on the cross section taken in a direction perpendicular to the extending direction of the electrodes, and the dielectric layer is formed with the virtually same thickness along the semi-circle of each electrode when viewed on the cross section taken in a direction perpendicular to the extending direction of the electrodes.

8. The plasma display panel according to claim 7, wherein each of the electrodes is a metal electrode made of a silver-paste fired film.
